(19) United States
(12) Patent Application Publication
(10) Pub. No.: US 2018/0134958 A1
(43) Pub. Date: May 17, 2018

(54) Biopolymer composition for remediating degraded soils and for preventing soil erosion

(71) Applicant: Nadia Adam, South Bend, IN (US)

(72) Inventor: Nadia Adam, South Bend, IN (US)

(21) Appl. No.: 14/623,072

(22) Filed: Feb. 16, 2015

(51) Int. Cl. C09K 17/50; C08L 97/02

(52) U.S. Cl. CPC C09K 17/50; C09K 2105/00; C08L 97/02

(57) ABSTRACT

The said biopolymer is derived from corn cob waste. The said biopolymer is of specific charge, size, and length, to facilitate aggregation, and create, or improve soil structure, and thus reduce and/or prevent soil erosion, and remediate degraded soils. The said biopolymer is of equal, or better efficacy (for the same dose) as polyacrylamide.

### BACKGROUND OF THE INVENTION

### (1) Field of the Invention

The present invention relates to soil conditioning with flocculating agents, coagulants and stabilizers. The current invention comprises a biopolymer soil conditioner based on cellulose microfibrils of specific charge, size and length to span between large numbers of soil particles. The biopolymer composition may be used as soil-binding biomaterials that, either alone or in combination with known polymers, act to condition soil and thereby prevent or retard soil erosion and water infiltration.

### (2) Description of the Related Art

Soil erosion is a potent threat to agricultural productivity and water quality causing the loss of top-soil rich in humus, runoff of nutrients and agricultural chemicals especially in semiarid and arid regions. In addition, with soil erosion, the applied chemical pesticides and herbicides pollute surface and ground waters. Also, nutrient leaching from runoff causes eutrophication. In urbanized areas and construction sites sediment runoff is a major problem due to erosive action of rainfall [Orts et al., 2007]. Humus and polysaccharides that provide soil structure via aggregate stabilization and profile development also play an important role in mineral cycling and weathering. Therefore their loss during soil erosion needs to be rapidly replaced to rehabilitate eroded soils and restore their moisture holding capacity [Theng, 1982].

Synthetic polymers have been used since the early 1950s as soil conditioners and soil stabilizers to restore eroded soils to favorably effect seed germination, seedling emergence, and crop yield. Synthetic polymers include linear hydrolyzed polyacrylonitrile (commercial name Krilium by Monsanto Chemical Company), synthetic carboxylic polymer in the calcium form (CRD-186), poly (2-methyl-N-vinyl-imidazole), poly (styrene-2-ethylexylacrylate), polyvinyl alcohol, cationic/anionic/neutral polyacrylamide, carboxymethyl cellulose, sulfonated lignin, high molecular weight polyethylene-oxide, and synthetic polymers grafted on anionic starches and several others [Bouranis et al., 1995]. However, all the above polymers, although ranging in remediation efficacy with some being very effective like polyacrylamide are expensive to synthesize, petroleum based, and non-biodegradable.

Several natural polymers combined with synthetic polymers yielding carboxymethyl starch, starch-g-poly(acrylic) acid, and hydrolyzed starch-g-polyacrylonitrile have been tested as soil conditioners but were less effective than their purely synthetic counterparts [Weaver et al., 1994].

Among synthetic polymers, co-polymers of polyacrylamide have been extremely effective and economical, although less effective in sprinkler irrigation than furrow irrigation. Currently, PAM is added to irrigation water to reduce irrigation runoff while improving water infiltration. The high molecular weight anionic PAM is added to irrigation water at very low concentration (at 2-10 g per cu.m, or 2-10 ppm) during the first several hours of irrigation. Soil-amending polymers are generally dissolved in irrigation water at doses of 2 to 20 parts per million, which converts to about 2 to 10 lbs per acre.

In addition to conventional soil erosion control, PAM is also used in a wide variety of other applications. For example, PAM is effective in sealing unlined water-delivery canals to reduce water seepage or infiltration losses. Other applications include controlling dust emissions at (for example) construction sites, rural roads, deforested areas—especially after fires or natural disasters, and at temporary helicopter landing pads and military air strips.

Since the early 1950s polyacrylamide (PAM) has been in use, however, it is now regarded as a macropollutant, with low toxicity, and side effects. The main environmental concern of petroleum derived PAM is its biodegradation and/or bioaccumulation. The long-term effect of PAM on living organisms in the soil application context is relatively unknown. The main concern stemming from PAM application is the presence of unreacted residual acrylamide monomer (AMD) not only a suspected carcinogen and mutagen in humans and animals but also a mutagen for bacteria and is easily absorbed and can cross metabolic barriers [Sojka et al., 2007]. There is also a concern that the monomer may occur as a degradation product due to early removal of the amine group from the polymer backbone [Kay-Shoemake and Watwood, 1996].

It is also being increasingly realized that PAM efficacy very much varies with and sodicity, texture, bulk density, and surface charge-related properties. It would also be beneficial to have a wide array of polymers with potentially different soil-stabilizing mechanisms, applicable to different soil types [Sojka et al., 1998b].

It is also important to note that PAM is a synthetic polymer using a non-renewable monomer source from oil refining.

It is evident that alternative materials would broaden the potential market for soil additives. Deriving an effective soil amendment from a renewable feedstock, especially from an agricultural waste stream would not only be cost-effective but also greatly enhance environmental sustainability. In addition, because degradation products of natural polymers are completely or relatively benign, they will be deemed safer by the public.

Potential alternatives to PAM, such as polysaccharides, amino acid polymers and other modified biopolymers have been introduced to provide soil amending properties similar to PAM. These alternatives rapidly degrade and provide marketing advantages due to the relative safety of natural compounds. Among these are natural and modified polysaccharides, polyamino acids (U.S. Pat. Nos. 7,595,002 and 7,595,007), starch xanthate, and chitosan.

Other alternatives to PAM include cellulose and starch xanthates considering that they have been applied as flocculating agents [Maher, 1981; Coltrinari, 1994] and soil stabilizers [Meadows, 1956, 1959; Swanson, et al. 1975; Menefee and Hautala, 1978].

Similar to PAM, xanthates carry a charge derived from carbon disulfide group, high molecular weight, and are readily water soluble. In fact, amylopectin a component of a starch xanthate derivative has molecular mass much greater than that of most PAMs.

However, although xanthates themselves may be environmentally safe with their degradtion products providing a source of sulfur to highly calcareous soils, the xanthate production poses environmental risks. This because the Viscose process for producing rayon fibers via xanthates is becoming increasingly obsolete due to large scale production of sulfur-based waste products. Further, the washing process during production leaves large quantities of sulfur-tainted water.

In addition to starch xanthates, chitosan similar to cellulose, with the hydroxyl in the 2-position replaced with a primary amino acid group is a natural biodegradable polymer that is already used as flocculating agent for treated heavy metals contaminated water, municipal water, and swimming pool water [Deans, 1993; Murcott and Harleman, 1994].

However, chitosan is not cost-effective as it costs at least $15/kg, almost twice the price of commercial PAM.

U.S. Pat. No. 8,410,194 B1 provides succulent-derived (biopolymer) additive (SDA) to be used alone or in combination with polymers and copolymers of PAM. The combination of the SDA and PAM is stated to have a synergistic effect then either of them acting alone. Therefore the need for PAM alternatives that are based on renewable resources and also reduces cost exist.

Cellulose microfibrils are readily available from various waste agricultural sources, and are therefore especially attractive. In addition, we expect EPA guidelines and state mandates to prohibit farmers from burning rice straw between seasons. Therefore, such straws, cotton waste, recycled cotton could potentially be a source of low cost microfibrils.

The current invention discloses a composition based on cellulose microfibrils of specific charge, size and length to span between large numbers of soil particles. The biopolymer composition may be used as soil-binding biomaterials that, either alone or in combination with known polymers, act to condition soil and thereby prevent or retard soil erosion and water infiltration. The biopolymer composition of the current invention provides better or comparable soil flocculating properties compared to PAM and also improve the handling characteristics. It will reduce the cost and environmental impacts of conventional commercially-available flocculants.

### BRIEF SUMMARY OF THE INVENTION

The current invention is for a composition comprising a biopolymer additive. When mixed with water the biopolymer additive functions as a soil conditioner. The additive is based on cellulose microfibrils of specific charge, size and length to span between large numbers of soil particles. The additive may be used alone or in combination with polymers and copolymers of polyacrylamide. The additive when used alone is as effective as PAM or in combination thereof. The current invention is also directed to a method of making the biopolymer composition. In accordance with the method of the current invention cellulose microfibrils of specific charge and length for different soil types can be designed to perform optimally. The biopolymer can be reconstituted when an additive is used. In one embodiment, polymers or copolymers of polyacrylamide are added to the composition.

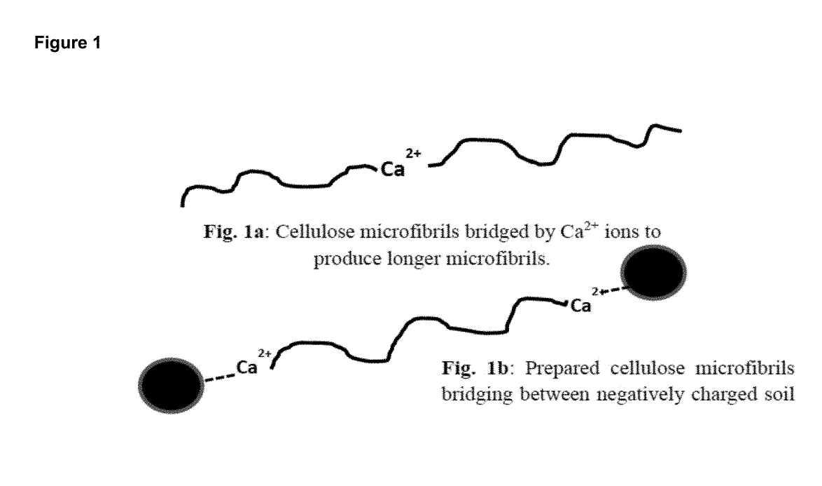

FIG. 1: a) Cellulose microfibrils bridged by Ca²⁺ ions to produce longer microfibrils; b) Prepared cellulose microfibrils bridging between negatively charged soil particles via cationic bridging.

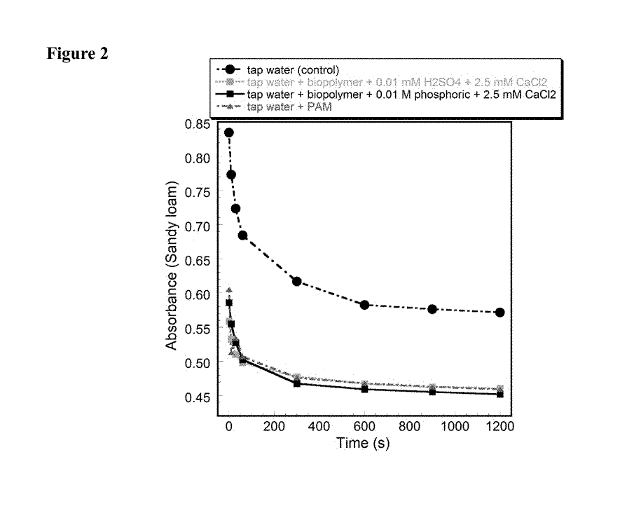

FIG. 2: Flocculation efficacy of sandy loam as determined by decreasing absorbance as a function vfvffvvvfvfvfvfvvvvfof time.

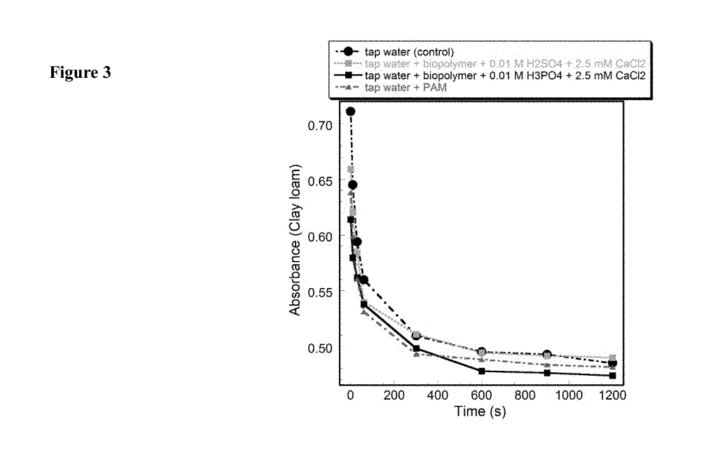

FIG. 3: Flocculation efficacy of clay loam as determined by decreasing absorbance as a function of time.

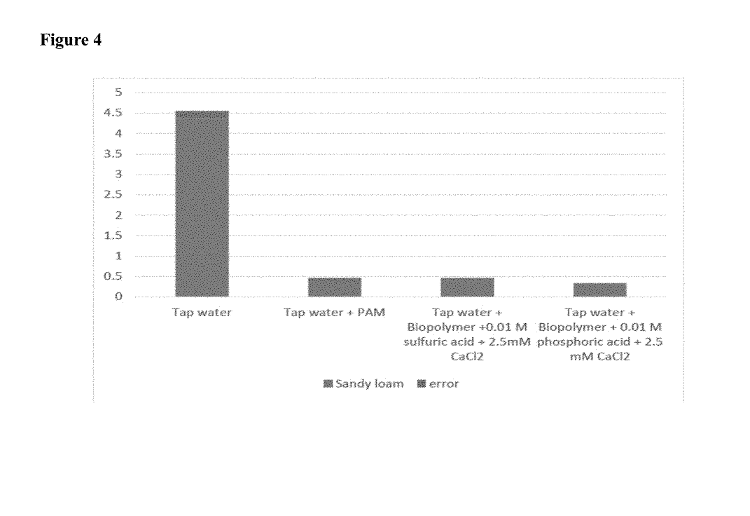

FIG. 4: Weight of eroded sediment from sandy loam in g for the tap water control, and PAM compared to CMCC-I (Tap water containing biopolymer treated with 0.01 M H₂SO₄ (H₃PO₄) and 2.5 mM CaCl₂

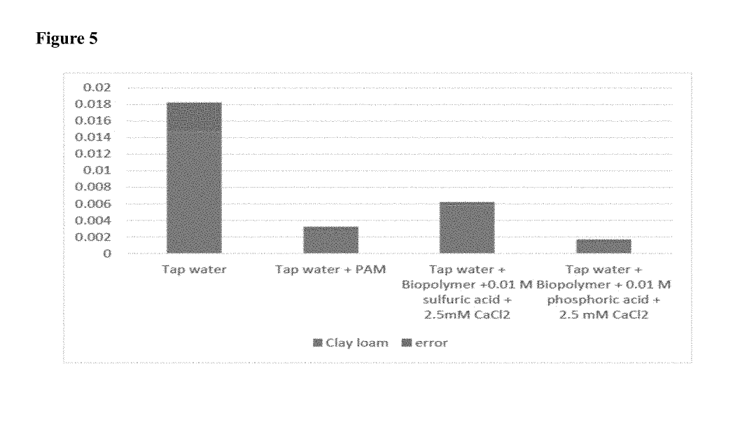

FIG. 5: Weight of eroded sediment from clay loam in g for the tap water control, and PAM compared to CMCC-I (Tap water containing biopolymer treated with 0.01 M H₂SO₄ (H₃PO₄) and 2.5 mM CaCl₂

### DETAILED DESCRIPTION OF THE INVENTION

As discussed supra, the present invention comprises a biopolymer additive that, in combination with water, functions as a soil conditioner. The additive comprises cellulose microfibrils derived from agricultural waste e.g., corn cob waste and treated with acid and calcium chloride.

Conventionally and for the purpose of this disclosure, agricultural waste streams comprise corn cob waste, rice straw, wheat straw, and sugar bagasse. In addition, other sources of cellulose microfibrils may also be utilized such as waste paper, plant biomass, algae, bacteria, saw dust etc.

Cellulose microfibrils are often extracted by mechanical, and chemical disintegration processes. The homogenization process of extraction, causes cellulose to be degraded with a marked increase in surface area and lateral dimensions of 10-100 nm but reduced length compared to the length of cellulose microfibrils in pristine plant samples. Cellulose microfibrils also contain alternating crystalline and amorphous forms which increases cross linking and hence gel forming ability of cellulose microfibrils.

Acid hydrolysis is often included as a pre-treatment to reduce the number of homogenization cycles and conserve energy. Orts et al., [2000] tested the conditioning efficacy of cellulose microfibrils isolated from cotton using an acid hydrolysis pre-treatment step treating with 60% sulfuric acid at 60° C. for 30 minutes. It is known that acid hydrolysis pre-treatment dissolves the amorphous form, removing it and producing a much more crystalline end product. This would have resulted in reduction in the length and lateral dimensions of the microfibril thus reducing cross linkage and consequently gel forming ability of the cellulose microfibrils isolated by Orts et al., [2000] and would explain their less than optimum conditioning efficacy.

Therefore as part of our preferred embodiment, we first refine the isolation process for producing cellulose microfibrils without any acid hydrolysis pre-treatment step.

In the preferred embodiment, lignin and hemicellulose is first removed from the corn cob waste by treatment with NaOH and NaOCl to derive cellulose gel. The cellulose gel is then treated with concentrated urea solution and cryo crushing to isolate individual cellulose microfibrils. It is important to note that no concentrated acid is used for this purpose to prevent dissolution of cellulose microfibrils and their consequent reduction in length.

Our second step in optimizing the mass, charge, length, and lateral dimensions of cellulose microfibrils will involve treating with low concentrations of H₂SO₄/H₃PO₄ and low concentrations Ca²⁺ not exceeding 2.5 mM CaCl₂. The cellulose microfibrils treated with dilute sulphuric acid or dilute phosphoric acid imparts them with negative charge density thus making them effective replacements for anionic PAM.

Finally, the cellulose microfibrils are treated with very low concentrations of CaCl₂ to further impart flocculating efficacy to the cellulose microfibrils. Calcium has been shown to have a very positive effect on the soil conditioning efficacy of PAM by cationic bridging between negatively charged clay particles and anionic PAM. As shown in FIG. 1a, Ca²⁺0 will both bridge between individual microfibrils increasing their length and cross linking as well as enhance the ability of microfibrils to binding to negatively charged clay particles.

As shown in FIG. 1, Ca²⁺ will both bridge between individual microfibrils increasing their length and cross linking as well as enhance the ability of microfibrils to binding to negatively charged clay particles.

As shown in FIGS. 2 and 3, we have tested the flocculation efficacy of our biopolymer treatments as compared to PAM and found comparable or better flocculation efficacy.

Similarly, we have also tested their efficacy for reducing soil erosion in simulated soil furrows and found comparable or better efficacy than PAM.

Invitro germination tests for corn and sorghum seeds showed that our biopolymer did not impede germination in any way.

In addition, all treatments of biopolymer treated with 0.001 M to 0.01 M acid and 1 mM, 2 mM or 2.5 mM CaCl₂ are water soluble and can be easily dried to a powder and thus prepared as solid or liquid formulations for easy field application.

### EXAMPLE 1

### Synthesis of Biopolymer

The synthesis procedure is novel and was carefully formulated to isolate cellulose microfibrils from corn cobs in individual microfibrils without reducing their length. The isolation of cellulose gel from corn cobs is based on Shogren et al., [2011]. Corn cobs free from corn kernels were air dried and ground to pass through a 2 mm screen. Ground corn cob powder in the amount of 220 g was added to 2 l of 1 M NaOH in a resin flask and heated at 80 degree C. while stirring slowly for 2 h. After cooling, suspension was filtered through Whatman 541 filter paper with 22 micron pore size. The residue was washed 3-4 times with water. The NaOH extraction was repeated two more times. The combined extract was added to 0.6% NaOCl and heated at 80 degree C. for 2 hours while stirring intermittently. The resulting white, water swollen gel was stored at 4 degree C. after cooling. One liter of cellulose gel suspension was diluted to 2% concentration and the suspension was made to a concentration of 8 M in urea. The suspension was heated to 70-80 degree C. and then centrifuged at 7000 rpm for 10 minutes. The precipitate was separated and washed with DI water five times to remove urea. The precipitate was cryo-crushed in a mortar and pestle using liquid nitrogen. Treatment with urea followed by cryo-crushing of the precipitate was repeated three times. The resulting precipitate was made to 2% concentration and blended in the waring blender for five minutes and filtered through a 60 mesh filter and stored at 4 degree C. This novel combination of treatment with urea, cryo-crushing is designed to separate individual microfibrils without reducing their length. The microfibril suspension was further treated with sulfuric acid and phosphoric acid to increase its charge density. For this, microfibril suspension was made to 2% concentration and sufficient sulfuric acid (or phosphoric acid) was added to make it to 0.01 M molar in concentration. The suspension was placed in a temperature controlled incubator shaker at 25 degree C. for 1 h. It was then washed with tap water three times and made to 2% concentration and filtered through 60 mesh filter. The acid treated microfibril suspension was further treated with CaCl₂ by washing it three times. Calcium has a double charge and a small hydrating radius which favors flocculation. Its cations have 45 times more flocculating power than Na⁺, 25 times more than K⁺ and 1.7 times more than Mg²⁺ [Sojka et al., 2007]. Washing involved adding CaCl₂ to make it to required concentration then placing the suspension in a temperature controlled water bath shaker at 25 degree C. for 1 h. The suspension was centrifuged and washed with tap water three times. The solid residue was again dispersed in tap water, filtered through a 60 mesh filter and store at 4 degree C. Thus two different samples of biopolymer were obtained: 1) biopolymer treated with 0.01 M H₂SO₄ and 2.5 mM CaCl₂; and 2) biopolymer treated with 0.01 M H₃PO₄ and 2.5 mM CaCl₂.

### EXAMPLE 2

### Lab Scale Testing of Flocculation Efficacy

25 mg soil sample was added to 10 ml distilled water with and without biopolymer additive added at a concentration of 10 ppm. Two replicates were used for each measurement. The sample was mixed thoroughly in a vortex mixer and the suspension was pipetted into the cuvette from a stock solution. The suspension was stirred gently and then allowed to settle. The aliquots were withdrawn from the suspended samples, and their absorbance was measured at 400 nm wavelength at 3 s, 10 s, 30 s, 60 s, 300 s, 600 s, 900 s, and 1200 s i.e., up to 20 minutes using a UV-Vis spectrophotometer.

### EXAMPLE 3

### Lab Scale Soil Erosion Tests

The furrows were comprised of six foot lengths of polyurethane pipe insulation of 0.5 inch diameter cut into half cylinders and inclined on support scaffolding.

The slope of the simulated furrows was set at 10 degrees for all measurements. A 200 g coating of soil (clay loam, and sandy loam) was distributed along the length of the furrow. Soils were dried, sieved and re-moisturized to 18% (w:w) water contents to use in the formation of furrows. The surface of the soil was pressed into a concave shape to simulate an actual furrow. The outflow from the furrow was collected in a sampling vial at the bottom of the furrow. Water was directed down the furrow using a peristaltic pump to obtain water flow of 20 ml/minute. Additive free tap water as negative control and PAM at 10 ppm as a positive control were used. The amount of sediment collected in the vial was dried and measured for all four treatments, tap water (control), 10 ppm PAM, 10 ppm biopolymer treated with 0.01 M H₂SO₄ and 2.5 mM CaCl₂ and 10 ppm biopolymer treated with 0.01 M H₂SO₄ and 2.5 mM CaCl₂.

### REFERENCES

Bouranis, D. L., A. G. Theodoropoulos, and J. B., Drossopoulos, 1995, Designing synthetic polymers as soil conditioners, Communications in Soil Science and Plant Analysis, 26:1455-1480.
Coltrinari, E., 1994. Selective Recovery of Heavy Metals Using Xanthates, U.S. Pat. No. 5,320,759.
Deans, J. R., 1993. Removing Polyvalent Metals from Aqueous Waste Streams with Chitosan and Halogenating Agents, U.S. Pat. No. 5,336,415.
Kay-Shoemake, J. L., Watwood, M. E., 1996. Microbial ecology of polyacrylamide application in agricultural soils. In: Sojka, R. E., Lentz, R. D. (Eds.), Managing Irrigation-Induced Erosion and Infiltration with Polyacrylamide, Proceedings, 6-8 May, Twin Falls, Id., Univ. of Idaho Misc. Pub. 101-96, pp. 33-41
Maher, G. G., 1981. Flocculation of Coals with Water-soluble Starch Xanthates, U.S. Pat. No. 4,253,970.
Meadows, G. W., 1956. Process for Conditioning Soil with Polysaccharide Xanthates, U.S. Pat. No. 2,761,247.
Meadows, G. W., 1959. Cement and Method of Stabilizing Soil. U.S. Pat. No. 2,884,334.
Menefee, E., Hautala, E., 1978. Soil stabilization by cellulose xanthate. Nature 275, 530-532.
Murcott, S. E., Harleman, D. R. F., 1994. Method of Drinking Water Treatment with Natural Cationic Polymers, U.S. Pat. No. 5,543,056.
Orts W. J., Robert E. Sojka and Gregory M. Glenn, 2000, polymer additives to reduce erosion-induced soil losses during irrigation, Industrial crops and products, 11: 19-29.
Orts W. J., Robert Sojka, Gregory M. Glenn, and Richard A. Gross, 1999. Preventing soil erosion with polymer additives, Polymer news, 24:406-413.
Orts W. J., Aicardo Roa-Espinosa, Robert Sojka, Gregory M. Glenn, Syed H. Imam, Kurt Erlacher, and Jan Skov Pederson, 2007. Use of synthetic polymers and biopolymers for soil stabilization in agricultural, construction, and military applications, Journal of Materials in Civil Engineering, 19:58-66.
Shogren, R. L., Peterson, S. C., Evans, K. O., and Kenar, J. A., 2011. Preparation and characterization of cellulose gels from corn cobs. Carbohydrate Polymers. 86: 1351-1357
Sojka, R. E., R. D. Lentz, T. J. Trout, C. W. Ross, D. L. Bjorneberg, and J. K. Aase. 1998. Polyacrylamide effects on infiltration in irrigated agriculture. J. Soil Water Conserv. 53:325-331.
Sojka R. E., D. L. Bjorneberg, J. A. Entry, R. D. Lentz, and W. J. Orts, 2007, Polyacrylamide in agricultural and environmental land management, Advances in Agronomy, 92:75-162
Swanson, C. L., Wing, R. E., Doane, W. M., 1975. Removal of Heavy Metal Ions from Wastewater, U.S. Pat. No. 3,947,354.
Theng, B. K. G., 1982, Clay—polymer interactions: summary and perspectives, Clays and Clay Minerals, 30(1): 1-10.
Weaver, M. O., F. H. Otey, and W. M. Doane, 1984, Effect of some anionic starches on the stability of soil particles in water, Starch, 36:56-60.
Orts et al., 2013. Biopolymer additive U.S. Pat. No. 8,410,194B1

What is being claimed is:

1. A soil conditioner comprising a corn cob waste derived cellulose microfibrils biopolymer additive, wherein the soil conditioner is structured to modify a soil to water interface so that the composition controls erosion or water infiltration.

2. The biopolymer of claim 1 that can be used in addition to a soil conditioner as a flocculant for waste water, metal contaminated water, and municipal water, for treating potable water, and swimming pool water.

3. The polymer of claim that can be additionally used in food processing and animal feeds.

4. The polymer of claim 1 that can be additionally used in mining, biosolids dewatering, paper production, clarifying refined sugar and fruit juices and to thicken animal feeds.

5. The polymer of claim 1 that can be additionally used for construction site protection, road-cut protection, helicopter landing pads protection, and for remediating degraded soils with poor soil structure.

6. The soil conditioner of claim 1 which can also be derived from rice straw, wheat straw, and sugar bagasse, or any other cellulose source such as waste paper, plant biomass, algae, bacteria, and saw dust.

7. The soil conditioner of claims 1 and 2 wherein the soil conditioner comprises a flocculant.

8. The soil conditioner of claims 1 and 2 wherein the biopolymer additive is combined with water so that the additive in the water is in the range of 10 ppm to 20 ppm.

9. The soil conditioner of claims 1 and 2 which is treated with 0.001 to 0.01M sulfuric or phosphoric acid or any other acid/base/chemical entity conferring negative, positive charge or additional functionality to the biopolymer.

10. The soil conditioner of claims 1, 2, 3, 4, and 5 additionally treated with 1 mM to 2.5 mM CaCl₂ or smaller or greater concentration of CaCl₂ or NaCl or any salt or ionic or non-ionic solvent.

11. The soil conditioner of claims 1 and 2 additionally treated with 1 mM to 2.5 mM CaCl₂ or smaller or greater concentration of CaCl₂ or NaCl or any salt or ionic or non-ionic solvent or salt.

12. The soil conditioner of claim 1 wherein the biopolymer additive is derived from waste stream substrates to produce cellulose microfibrils.

13. The soil conditioner of claims 1 and 2 wherein the biopolymer comprises extracted cellulose microfibrils so that the composition comprises the biopolymer from different substrates in combination with the synthetic additive like PAM.
